(19) United States
(12) Patent Application Publication
(10) Pub. No.: US 2026/0002398 A1
(43) Pub. Date: Jan. 1, 2026

(54) DEVICE FOR AUTOMATICALLY OPENING AND CLOSING DOOR OF VEHICLE AND CONTROL METHOD THEREFOR

(71) Applicant: HYUNDAI MOBIS CO., LTD., Seoul (KR)

(72) Inventors: Tae Hyun KIM, Yongin-si (KR); In Seok KIM, Yongin-si (KR); Ho In JUNG, Yongin-si (KR); Hyung June CHOI, Yongin-si (KR)

(73) Assignee: HYUNDAI MOBIS CO., LTD., Seoul (KR)

(21) Appl. No.: 19/201,108

(22) Filed: May 7, 2025

(30) Foreign Application Priority Data
Jul. 1, 2024 (KR) 10-2024-0086231

(51) Int. Cl. E05F 15/40; E05F 15/611; E05F 15/70

(52) U.S. Cl. CPC E05F 15/40; E05F 15/611; E05F 15/70; E05Y 2400/356; E05Y 2400/812; E05Y 2900/531

(57) ABSTRACT

A device for opening and closing a vehicle door including a processor that detects an obstacle around a vehicle based on an opening command signal or a closing command signal of the vehicle door and calculates a distance to the detected obstacle, and an actuator that controls a motor to open or close the vehicle door based on the detected obstacle or the distance to the obstacle. The processor controls the actuator to open or close the vehicle door at one of a plurality of opening levels or a plurality of closing levels based on the detection of the obstacle or the distance to the obstacle, and the plurality of opening levels and the plurality of closing levels exclude a fully closed level and a fully open level of the vehicle door.

### CROSS-REFERENCE TO RELATED APPLICATION

Pursuant to 35 U.S.C. § 119 (a), this application claims the benefit of earlier filing dates and right of priority to Korean Application No. 10-2024-0086231, filed on Jul. 1, 2024, the contents of which are hereby incorporated by reference herein in their entirety.

### BACKGROUND

### Field of the Disclosure

The present disclosure relates to an automatic opening/closing device of a vehicle door and a control method therefor, and more specifically, to a device for opening and closing a vehicle door based on a door opening or closing command and a control method therefor.

### Discussion of the Related Art

Ghost closing or soft closing provides a motion to completely close a door of a vehicle within a certain range. In this regard, only a safety device that stops the motion when a certain torque is applied to a motor for closing the door exists, and accordingly, finger jamming and amputation accidents often occur.

In addition, recently, vehicles that provide a function of opening or closing the door of the vehicle electrically have been commercialized, but the opening and closing are achieved within a limited range and active protection means for safety are not provided.

The present disclosure is to propose a scheme for opening or closing the vehicle door based on a presence of an obstacle around the vehicle or a distance thereto via a nearby obstacle detection means installed in the vehicle.

### SUMMARY

Based on the aforementioned background, the present disclosure is intended to provide an automatic opening/closing device of a vehicle door and a control method therefor.

Problems of the present disclosure are not limited to the problems described above. Other problems not mentioned above may be understood by a person skilled in the art from a description of the present disclosure below.

Proposed is a device for opening and closing a vehicle door, the device including a processor that detects an obstacle around a vehicle based on an opening command signal or a closing command signal of the vehicle door and calculates a distance to the detected obstacle, and an actuator that controls a motor to open or close the vehicle door based on the detected obstacle or the distance to the obstacle, wherein the processor controls the actuator to open or close the vehicle door at one of a plurality of opening levels or a plurality of closing levels based on the detection of the obstacle or the distance to the obstacle, wherein the plurality of opening levels and the plurality of closing levels exclude a fully closed level and a fully open level of the vehicle door.

The processor may be configured to activate an automatic door opening/closing mode based on the command signal for opening or closing the vehicle door.

The processor may be configured to, in response to reception of the command signal for opening the vehicle door, control the actuator to open the vehicle door at an opening level corresponding to the distance to the obstacle.

The processor may be configured to, in response to reception of the command signal for opening the vehicle door, control the actuator to open the vehicle door at a preset opening level.

The processor may be configured to switch an automatic door opening/closing mode to a manual door opening/closing mode and output an alarm notifying the switch.

The processor may configured to, in response to reception of the command signal for closing the vehicle door, attempt to detect an obstacle, and control an alarm notifying the presence of a nearby obstacle to be output when the obstacle is detected.

The processor may be configured to switch an automatic door opening/closing mode to a manual door opening/closing mode and output an alarm notifying the switch when the alarm notifying is the presence of the nearby obstacle is output a preset number of times.

The processor may be configured to, in response to reception of the command signal for closing the vehicle door, attempt to detect an obstacle and control the actuator to close the vehicle door at a next closing level of a closing level of the vehicle door when the obstacle is not detected, and the next closing level may include a closing level where the vehicle door is closed more than a current closing level.

Proposed is a method for opening and closing a vehicle door performed by a device for opening and closing the vehicle door including a processor that detects an obstacle around a vehicle based on an opening command signal or a closing command signal of the vehicle door and calculates a distance to the detected obstacle, and an actuator that opens or closes the vehicle door based on the detected obstacle or the distance to the obstacle, the method including receiving an opening or closing control command signal of the vehicle door, and controlling the vehicle door to be opened or closed at one of a plurality of opening levels or a plurality of closing levels based on the detection of the obstacle or the distance to the obstacle, wherein the plurality of opening levels or the plurality of closing levels exclude the fully closed and the fully open level of the vehicle door.

Proposed is a vehicle including a sensor that obtains data for detecting an obstacle around the vehicle, a processor that detects the obstacle around the vehicle based on an opening command signal or a closing command signal of the vehicle door and calculates a distance to the detected obstacle, and a vehicle door opening/closing device including an actuator that opens or closes the vehicle door based on the detected obstacle or the distance to the obstacle, wherein the processor controls the vehicle door to be opened or closed at one of a plurality of opening levels or a plurality of closing levels based on the detection of the obstacle or the distance to the obstacle, wherein the plurality of opening levels or the plurality of closing levels exclude the fully closed level and the fully open level of the vehicle door.

The solutions of the present disclosure described above are a part of embodiments of the present disclosure. Various solutions other than the solutions of the problem described above may be derived and understood based on a detailed description of the present disclosure to be described below.

The present disclosure has following effects.

The vehicle door may be opened and closed electrically or automatically.

When opening and closing the vehicle door electrically or automatically, the accident such as the finger jamming or the collision between the door and the object or the item around the vehicle may be prevented.

Effects of the present disclosure are not limited to the effects described above. Other effects not mentioned above may be understood by those skilled in the art from a description of the present disclosure below.

### BRIEF DESCRIPTION OF THE DRAWINGS

The accompanying drawings, which are included as a portion of a detailed description to aid in understanding the present disclosure provide embodiments of the present disclosure and, together with the detailed description, describe content of the present disclosure.

FIG. 1 is an overall block diagram of an autonomous vehicle to which an autonomous driving apparatus is applicable.

FIG. 2 is a diagram illustrating an example in which an autonomous driving apparatus is applied to a vehicle.

FIG. 3 illustrates a block diagram of a vehicle door opening/closing device or system 1 according to the present disclosure.

FIG. 4 illustrates a block diagram of a processor of a vehicle door opening/closing device or system 1 according to the present disclosure.

FIG. 5 illustrates a block diagram of an actuator for door opening/closing of a vehicle door opening/closing device or system 1 according to the present disclosure.

FIG. 6 illustrates a flowchart of a method for controlling opening of a vehicle door according to the present disclosure.

FIG. 7 illustrates a flowchart of a method for controlling closing of a vehicle door according to the present disclosure.

FIG. 8 illustrates a trajectory based on opening or closing of a vehicle door according to the present disclosure.

FIG. 9 illustrates an opening or closed state of a door based on an opening or closing level of a vehicle door according to the present disclosure.

### DETAILED DESCRIPTION

Hereinafter, embodiments of the present disclosure will be described with reference to the accompanying drawings.

The embodiments to be described below are intended to aid in understanding the present disclosure, and therefore the present disclosure is not limited to the embodiments to be described below. In addition, in the attached drawings, certain components may be exaggerated or reduced to aid in understanding the present disclosure. The present disclosure is not limited to the forms depicted in the attached drawings.

In the specification, when a part “includes” an element, it means that the part may further include another element rather than excluding another element unless otherwise mentioned.

Additionally, it is noted that terms “passenger”, “driver”, “user”, and the like are mentioned in the present document to describe the present disclosure, and are able to be used interchangeably.

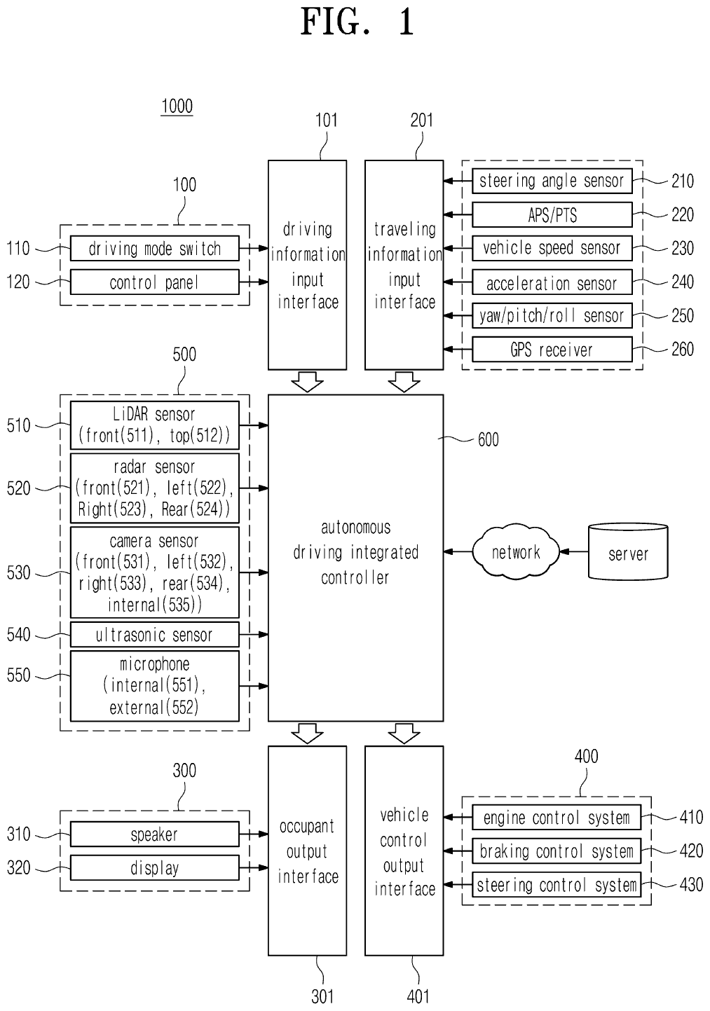

FIG. 1 is an overall block diagram of an autonomous driving control system to which an autonomous driving apparatus according to any one of embodiments of the present disclosure is applicable.

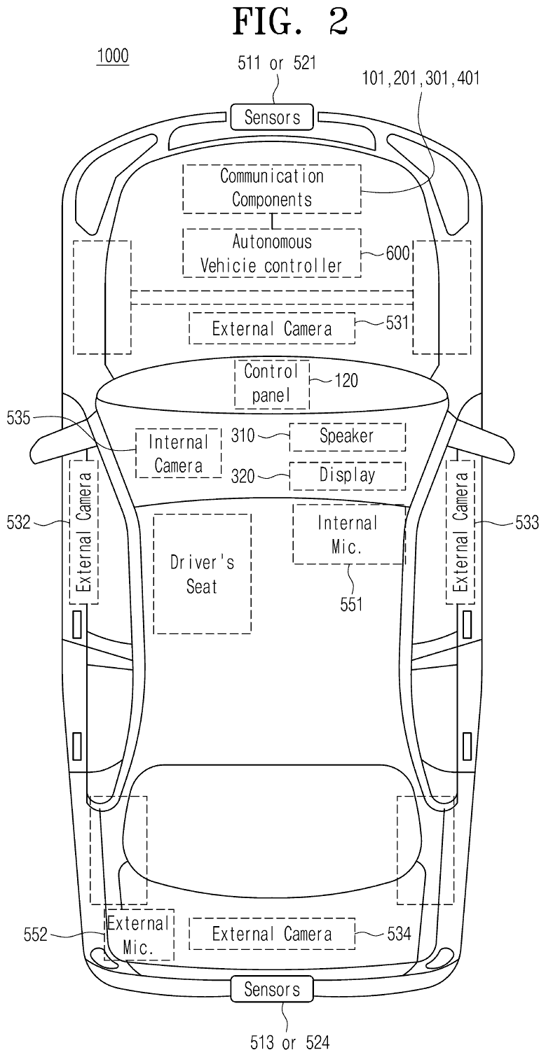

FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LIDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

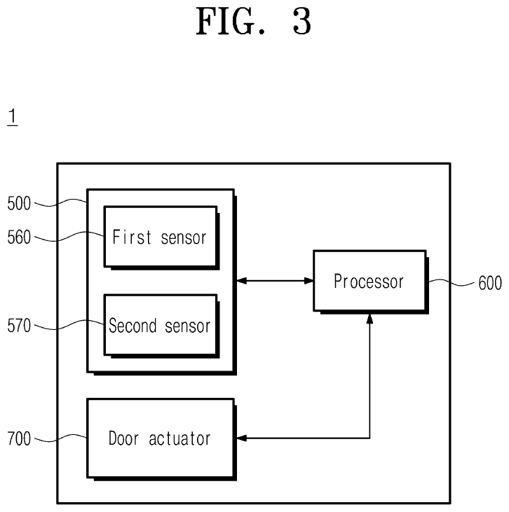

FIG. 3 illustrates a block diagram of a vehicle door opening/closing device or system 1 according to the present disclosure.

The vehicle door opening/closing device 1 may include a sensor 500 that obtains data for detecting an obstacle around a vehicle.

The vehicle door opening/closing device 1 may include a processor 600 configured to detect the obstacle based on the data obtained by the sensor 500 and calculate a distance to the detected obstacle.

The vehicle door opening/closing device 1 may include an actuator 700 that opens or closes a vehicle door of the vehicle based on the detected obstacle or the distance to the detected obstacle.

In this regard, the vehicle door may be controlled to open or close at one of a plurality of opening levels or a plurality of closing levels depending on the detection of the obstacle or the distance to the obstacle.

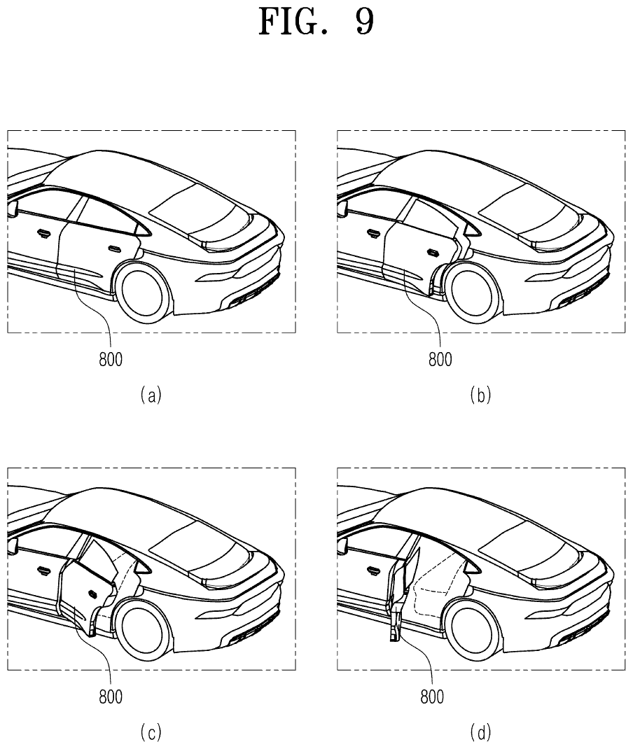

In the present document, the “opening level” indicates an opening state of the vehicle door, and is able to indicate a degree of opening as an angle of opening or a percentage of opening based on a state in which the door is completely opened or not opened. The “closing level” indicates a closed state of the vehicle door, and is able to indicate a degree of closing as an angle of closing or a percentage of closing based on a state in which the door is completely closed or not closed. The opening level and the closing level may refer to FIG. 9.

The sensor 500 may include a first sensor 560 and a second sensor 570, but the present disclosure may not be limited thereto.

The sensor 500 may be composed of only a single sensor. In this case, the single sensor may be a composite sensor capable of obtaining a plurality of sensor data (e.g., an image, an ultrasound, a radar, a lidar, and the like).

The sensor 500 may include the first sensor composed of a plurality of cameras for capturing surroundings of the vehicle and the second sensor composed of a plurality of ultrasonic sensors for detecting the obstacle around the vehicle. In addition, the sensor 500 may include a proximity sensor (e.g., an ultrasonic sensor) installed around the vehicle door. For example, an ultrasonic sensor may be installed around a door catch (a handle) of the vehicle door. As another example, an ultrasonic sensor may be installed at a lower end of a B pillar or a lower end of a door step of the vehicle.

In one example, an embodiment in which the sensor 500 is not included in the vehicle door opening/closing device 1 may also be implemented. In this case, the vehicle door opening/closing device 1 may be composed of the processor 600 and the door actuator 700.

In one example, although not shown, a speaker, a light emitting element, a display, and the like for outputting a warning alarm or a warning alarm display may be included in the vehicle door opening/closing device 1.

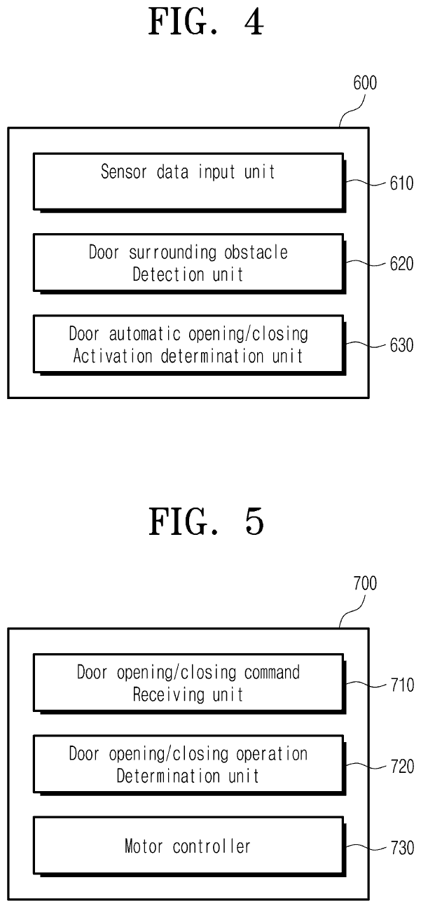

The processor 600 and the door actuator 700 will be described with reference to FIGS. 4 and 5.

FIG. 4 illustrates a block diagram of the processor 600 of the vehicle door opening/closing device or system 1 according to the present disclosure. Hereinafter, individual components 610, 620, and 630 of the processor 600 will be described, and a function or an operation of each component will be described, but two or more of the individual components may be integrated into one depending on implementation.

The processor 600 may include a sensor data input unit 610, a door surrounding obstacle detection unit 620, and a door automatic opening/closing activation determination unit 630. Although not illustrated, the processor 600 may include a component such as a transceiver that may exchange commands, signals, data, and the like with the actuator 700.

The sensor data input unit 610 may receive the data measured or obtained by the sensor 500.

The door surrounding obstacle detection unit 620 may be configured to detect the obstacle around the vehicle door and calculate the distance to the detected obstacle. The data received via the sensor data input unit 610 may be used for the obstacle detection and the distance calculation.

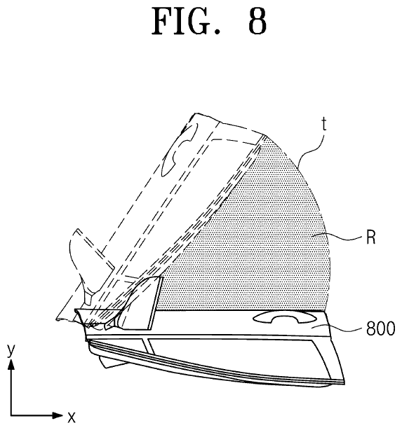

The ultrasonic sensor of sensor 500 may be installed at an end of the vehicle door. A distance from the end of the vehicle door to the obstacle may be calculated based on data of the ultrasonic sensor installed at the end of the vehicle door. The distance to the detected obstacle may be calculated by considering a trajectory of the vehicle door based on the opening and closing of the vehicle door. Referring to FIG. 8, a schematic top view of a trajectory t based on opening and closing of a vehicle door 800 is illustrated. An x-axis represents a longitudinal axis of the vehicle, and a y-axis represents a transverse axis of the vehicle. The obstacle present in an area R located inward of the trajectory t of the vehicle door 800 and a partial area located outward of the trajectory t is a target of the detection. In addition, not only a measurement value of the sensor 500, but also a distance (hereinafter, an estimated distance) to a predicted position or an estimated position of the obstacle based on the measurement value of the sensor 500 may be calculated.

The door surrounding obstacle detection unit 620 or the processor 600 may transmit or provide, to the actuator 700, the calculated distance or the estimated distance to the obstacle.

In one example, it is preferable that the calculation of the distance or the estimated distance to the obstacle by the door surrounding obstacle detection unit 620 or the processor 600 is performed when a door opening/closing (opening or closing) command to be described later is received. In another embodiment, it is preferable that the calculation of the distance or the estimated distance to the obstacle by the door surrounding obstacle detection unit 620 or the processor 600 is performed when an activation condition of an automatic opening operation or an automatic closing operation to be described later is satisfied. In another embodiment, it is preferable that the calculation of the distance or the estimated distance to the obstacle by the door surrounding obstacle detection unit 620 or the processor 600 is performed when the door opening/closing (opening or closing) command to be described later is received and the activation condition of the automatic opening operation or the automatic closing operation to be described later is satisfied.

The door automatic opening/closing activation determination unit 630 may determine whether the condition for activating the automatic opening/closing (opening or closing) operation of the vehicle door is satisfied. The condition for activating the automatic opening/closing operation may be based on the degree of opening/closing of the vehicle door, a gear shift state of the vehicle, a travel speed of the vehicle, an ignition on/off state of the vehicle, and the like, but the present disclosure may not be limited thereto.

For example, the activation condition of the automatic opening operation may correspond to the vehicle ignition being turned off and the vehicle door being not completely open. As another example, the activation condition of the automatic opening operation may correspond to the gear shift of the vehicle being in a neutral (N) state, the travel speed of the vehicle being 0, and the vehicle door being not completely open. As another example, the activation condition of the automatic opening operation may correspond to the gear shift of the vehicle being in a parking (P) state and the vehicle door being not completely open.

For example, the activation condition of the automatic closing operation may correspond to the vehicle ignition being turned off and the vehicle door not being completely closed. As another example, the activation condition of the automatic closing operation may correspond to the gear shift of the vehicle being in the neutral (N), the travel speed of the vehicle being 0, and the vehicle door not being completely closed. As another example, the activation condition of the automatic closing operation may correspond to the gear shift of the vehicle being in the parking (P) state and the vehicle door not being completely closed.

The door automatic opening/closing activation determination unit 630 or the processor 600 may perform activation of the automatic opening operation or activation of the automatic closing operation depending on whether the activation condition of the automatic opening operation or the automatic closing operation is satisfied.

In one example, it is preferable that the determination of whether the activation condition of the automatic opening operation or the automatic closing operation is satisfied by the door automatic opening/closing activation determination unit 630 or the processor 600 is performed when the door opening/closing (opening or closing) command to be described later is received.

The door automatic opening/closing activation determination unit 630 or the processor 600 may transmit or provide, to the actuator 700, information on whether the activation condition of the automatic opening operation or the automatic closing operation is satisfied or the activation (or deactivation, non-activation, and the like) of the automatic opening operation or the automatic closing operation.

FIG. 5 illustrates a block diagram of an actuator for opening/closing a door of the vehicle door opening/closing device or system 1 according to the present disclosure. The “actuator” is a manipulation device that may adjust the opening/closing or the opening/closing level of the vehicle door, and a name thereof does not limit the present disclosure. For example, instead of the “actuator,” it may be referred to as a door opening/closing operator, a door opening/closing driver, and the like.

Hereinafter, individual components 710, 720, and 730 of the actuator 700 will be described, and a function or an operation of each component will be described, but two or more of the individual components may be integrated into one depending on implementation.

The actuator 700 may include a door opening/closing command receiving unit 710, a door opening/closing operation determination unit 720, and a motor controller 730. Although not shown, the actuator 700 may include a component such as a transceiver that may exchange commands, signals, data, and the like with the processor 600.

The door opening/closing command receiving unit 710 may receive a door opening command signal or a door closing command signal. The door opening command signal or the door closing command signal includes a signal generated by an action of the user or the driver.

For example, the door opening command signal may be generated by at least one of a push or touch of a door open button installed on a vehicle key (e.g., a FOB), a push or touch of a door unlock button installed on the vehicle key for a preset time, a push or touch of a vehicle door open button installed on a vehicle body or the door, and a release of a door lock latch of the door.

For example, the door closing command signal may be generated by at least one of a push or touch of a door close button installed on the vehicle key (e.g., the FOB), a push or touch of a door lock button installed on the vehicle key for a preset time, and a push or touch of the vehicle door open button installed on the vehicle body or the door.

When the door closing command signal or the door opening command signal is received, the door opening/closing command receiving unit 710 or the actuator 700 may transmit the received door closing command signal or door opening command signal to the processor 600.

The door opening/closing operation determination unit 720 may determine whether to perform door closing or door opening control. When the door closing command signal or the door opening command signal is received, the door opening/closing operation determination unit 720 may determine whether it is allowed to open the door or close the door based on the detection of the obstacle or the distance (including the estimated distance) to the obstacle. In addition, the door opening/closing operation determination unit 720 may determine whether to open or close the door or determine the opening/closing level of the door when the automatic opening operation or the automatic closing operation is activated based on whether the activation condition of the automatic opening operation or the automatic closing operation is satisfied or the activation information (or the deactivation, the non-activation, and the like) of the automatic opening operation or the automatic closing operation, provided from the processor 600.

The door opening/closing operation determination unit 720 may determine the closing level of the vehicle door (the degree to which the door is closed) or the opening level of the vehicle door (the degree to which the door is opened). Referring to FIG. 9, a closing level or an opening level of the vehicle door 800 is illustrated. (a) in FIG. 9 represents a level at which the vehicle door is completely closed, (d) in FIG. 9 represents a level at which the vehicle door is completely opened, and (b) and (c) in FIG. 9 represent intermediate levels therebetween. As proceeding from (a) to (d) in FIG. 9, the degree of opening of the vehicle door 800 increases.

The closing level or the opening level of the vehicle door may be set as follows.

TABLE 1

| | Door closing/opening level | | | |
|---|---|---|---|---|
| | K-th level | First level | M-th level | N-th level |
| Door closing degree | 100% | 70% | 30% | 0% |
| Door opening degree | 0% | 30% | 70% | 100% |

The closing level or the opening level of the vehicle door may be composed of a greater number of levels. Further, it is preferable that there are at least a plurality of levels excluding the level at which the door is100% closed or the door is 0% opened and the level at which the door is 0% closed or the door is 100% opened. This is to ensure safety during the door closing or door opening operation.

The closing level or the opening level of the vehicle door may be composed of a greater number of levels. Further, it is preferable that there are at least a plurality of levels excluding the level at which the door is100% closed or the door is 0% opened and the level at which the door is 0% closed or the door is 100% opened. This is to ensure safety during the door closing or door opening operation.

In addition, although each level mentioned in Table 1 sets the door opening or closing level of a preset degree, at least one of the levels may be a door opening or closing level corresponding to the distance (including the estimated distance) from the vehicle door or the vehicle body to the obstacle.

In one example, the door opening/closing operation determination unit 720 may determine whether to open or close the door or determine the door opening/closing level when the automatic opening operation or the automatic closing operation is activated. The activation of the automatic opening operation or the automatic closing operation may be identified based on whether the activation condition of the automatic opening operation or the automatic closing operation is satisfied or the activation information (or the deactivation, the non-activation, and the like) of the automatic opening operation or the automatic closing operation, provided from the processor 600.

When the closing or the opening of the vehicle door and the level thereof are determined, the door opening/closing operation determination unit 720 may transmit the vehicle door closing or opening command and the level thereof to the motor controller 730.

The motor controller 730 may control the motor for closing or opening the vehicle door. The motor controller 730 may control the motor based on the door closing level or the door opening level.

Although each component 610, 620, and 630 of the processor 600 and each component 710, 720, and 730 of the actuator 700 are separately described in FIGS. 4 and 5, some components of the actuator 700 may be integrated into the processor 600. For example, the door opening/closing command receiving unit 710 or the door opening/closing operation determination unit 720 may be included in the processor 600. In this case, the door opening/closing command may be received by the processor 600, or whether to perform the door opening or closing control or the opening/closing level may be determined by the processor 600.

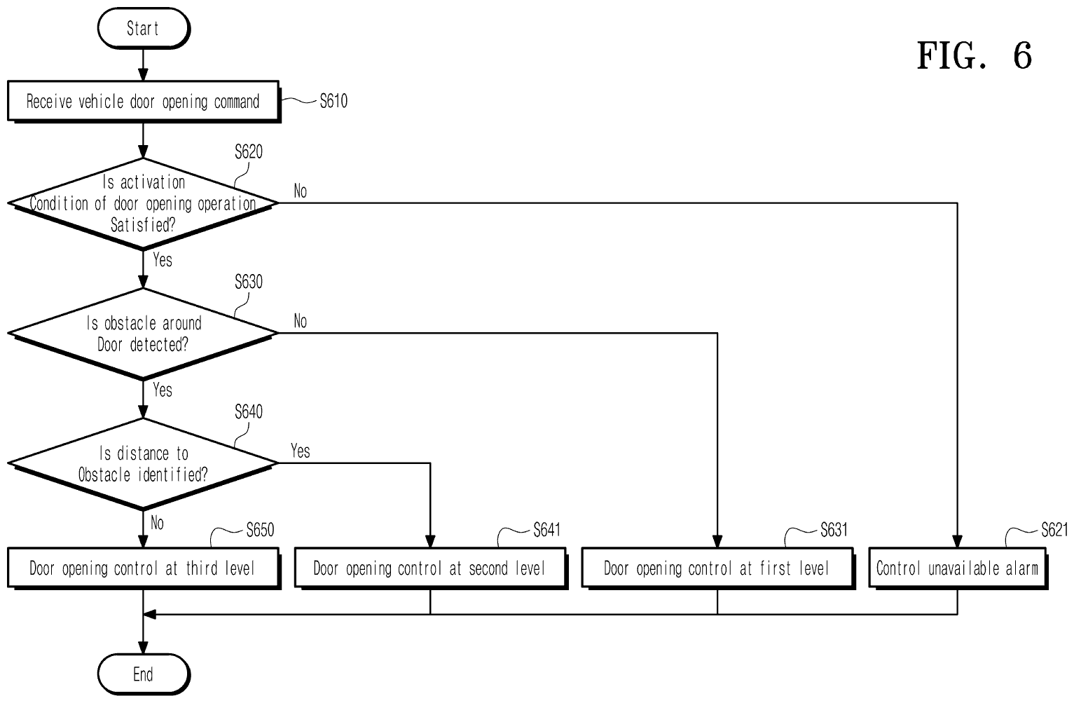

FIG. 6 illustrates a flowchart of a method for controlling opening of a vehicle door according to the present disclosure. The invention illustrated in FIG. 6 may be performed by the vehicle door opening/closing device or system 1 or the processor 600. Hereinafter, for simplicity of description, the invention in FIG. 6 will be described as being implemented by the device 1.

The device 1 may receive or detect the opening command signal of the vehicle door (S610).

When the opening command signal of the vehicle door is received, the device 1 may determine whether the activation condition of the vehicle door automatic opening operation is satisfied (S620). When the activation condition of the vehicle door automatic opening operation is not satisfied, the device 1 may output a control unavailable alarm (S621), and the procedure may be terminated.

When the activation condition of the door automatic opening operation is satisfied, the device 1 may set a vehicle door opening mode to an automatic door opening mode. When the vehicle door opening mode was a manual door opening mode, it may be switched to the automatic door opening mode. Refer to the above description for the activation condition of the vehicle door automatic opening operation.

When the activation condition of the door automatic opening operation is satisfied, the device 1 may identify whether the obstacle is detected around the vehicle door (S630). When no obstacle is detected around the vehicle door, the device 1 may control the vehicle door to open at a first level (S631). Here, the first level may be a level at which the vehicle door is maximally opened. This is for opening the vehicle door based on the opening command signal because safety is ensured as there is no obstacle around the vehicle door. The device 1 may output an alarm or an alarm display to notify that the vehicle door is opened at the first level.

When the obstacle is detected around the vehicle door, the device 1 may determine whether the distance (or the estimated distance) to the obstacle is identified or calculated (S640). When the distance (or the estimated distance) to the obstacle is identified or calculated, the device 1 may control the vehicle door to open at a second level (S641). The second level may be a door opening level corresponding to the distance (or the estimated distance) to the obstacle. This is to open the vehicle door only to a degree of avoiding collision or contact with the obstacle. The device 1 may output an alarm or an alarm display to notify that there is the nearby obstacle.

When the distance (or the estimated distance) to the obstacle is not identified or calculated, the device 1 may control the vehicle door to open at a third level (S650). Here, the third level may be a minimum opening level of the vehicle door. This is to open the vehicle door at a minimum level for the safety because the obstacle has been detected but the distance (or the estimated distance) to the obstacle has not been obtained. The device 1 may determine that the automatic opening operation may no longer be performed because the distance (or the estimated distance) to the obstacle is not obtained. Accordingly, the device 1 may switch the vehicle door opening mode to the manual door opening mode and output an alarm or an alarm display to notify the same.

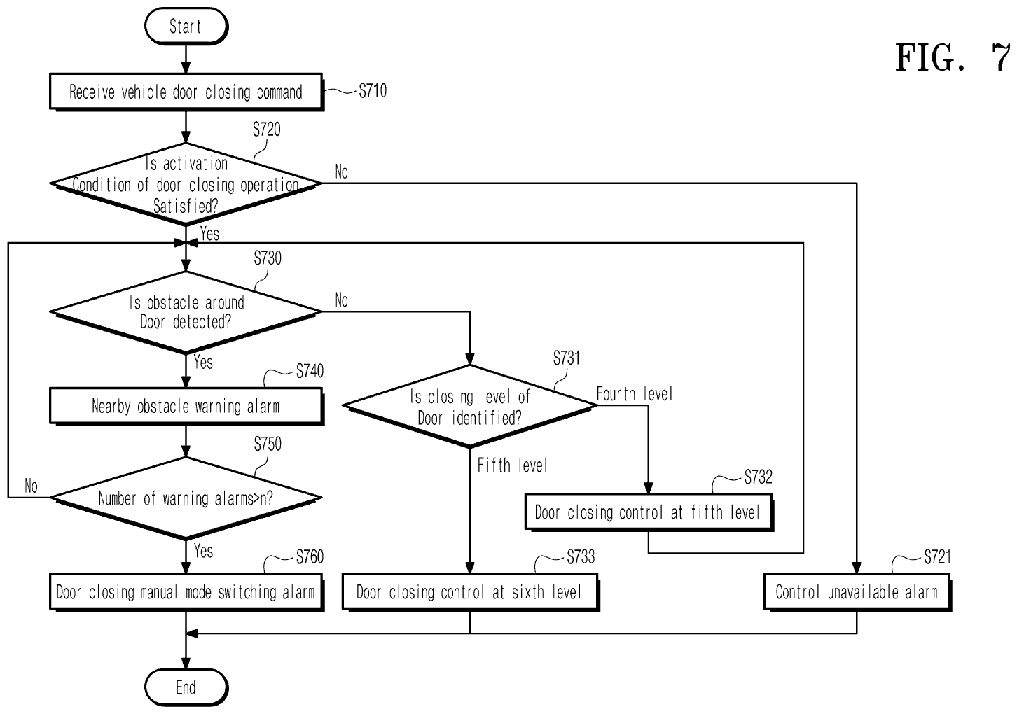

FIG. 7 illustrates a flowchart of a method for controlling closing of a vehicle door according to the present disclosure. The invention illustrated in FIG. 7 may be performed by the vehicle door opening/closing device or system 1 or the processor 600. Hereinafter, for simplicity of description, the invention in FIG. 7 will be described as being implemented by the device 1.

The device 1 may receive or detect the closing command signal of the vehicle door (S710).

When the closing command signal of the vehicle door is received, the device 1 may determine whether the activation condition of the vehicle door automatic closing operation is satisfied (S720). When the activation condition of the vehicle door automatic closing operation is not satisfied, the device 1 may output the control unavailable alarm (S721), and the procedure may be terminated. Refer to the above description for the activation condition of the vehicle door automatic closing operation.

When the activation condition of the door automatic closing operation is satisfied, the device 1 may set a vehicle door closing mode to an automatic door closing mode. When the vehicle door closing mode was a manual door closing mode, it may be switched to the automatic door closing mode.

When the activation condition of the door automatic closing operation is satisfied, the device 1 may identify whether the obstacle is detected around the vehicle door (S730). When no obstacle is detected around the vehicle door, the device 1 may identify the closing level of the vehicle door (S731). When the closing level of the vehicle door is a fourth level, the device 1 may control the vehicle door to be closed at a fifth level (S732). Here, the fourth level may be a level at which the vehicle door is not completely closed. Here, the fifth level may be a level at which the vehicle door is closed to a preset degree. This is to avoid an accident even when there is a very low probability of the accident caused by the complete closing of the vehicle door although there is no obstacle around the vehicle door and the safety is ensured.

Then, the device 1 may identify again whether the obstacle is detected around the vehicle door (S730). When no obstacle is detected around the vehicle door, the device 1 may identify the closing level of the vehicle door (S731). When the closing level of the vehicle door is the fifth level, the device 1 may control the vehicle door to close at a sixth level (S733). The device 1 may output an alarm or an alarm display to notify that the vehicle door is closed at the sixth level.

In this regard, the sixth level may be a level at which the vehicle door is maximally closed. That is, when no obstacle is detected around the door, the closing of the vehicle door is controlled in two stages to ensure the safety. As described above, because more closing levels of the vehicle door may be set, the closing of the vehicle door may be controlled in more stages than merely the two stages.

When the obstacle is detected around the vehicle door, the device 1 may output an alarm or an alarm display to warn that there is the nearby obstacle around the vehicle door (S740). When the alarm or the alarm display is output, the device 1 may increase a number of a counter that counts the number of alarm or alarm display outputs by 1. Thereafter, the device 1 may identify the number of alarm or alarm display outputs (S750).

When the number of alarm or alarm display outputs is not greater than a preset number (N), the device 1 may return to S730 and identify whether the obstacle is detected around the vehicle door. When the obstacle is continuously detected around the vehicle door (i.e., when the number of alarm or alarm display outputs exceeds N), the device 1 may determine that the vehicle closing control is not able to be performed anymore. The vehicle closing control is not performed because the collision accident with the obstacle may occur because of the vehicle door automatic closing control. In this case, the device 1 may switch the vehicle door opening mode to the manual door opening mode. Then, the device 1 may output an alarm or an alarm display to notify the manual door opening mode (S760).

In one example, as another embodiment of the present disclosure, a vehicle 1000 including the above-described device 1 is proposed.

In the present document above, the “device” or the “system” that controls the opening and closing of the vehicle door, or each component included therein has been described as performing the control, but the “device”, the “system” and the components included therein are only names and the scope of rights is not dependent on them.

In other words, the proposed technology may be realized by other names besides the device, the processor, or the controller, and in addition, the method, the scheme, or the like described above may be performed by a code readable by software, a computer, other machine, a device, or the like for vehicle control.

In addition, as another aspect of the present disclosure, the operation of the proposed technology described above may also be provided as a code that may be implemented, executed, or realized by a “computer” (a comprehensive concept including a system on chip (SoC), a (micro) processor, or the like), or a computer-readable storage medium or a computer program product storing or including the code. The scope of the present disclosure may be extended to the code or the computer-readable storage medium or the computer program product storing or including the code.

The detailed description of the preferred embodiments of the present disclosure disclosed as described above has been provided to enable a person skilled in the art to implement and practice the present disclosure.

Although the description has been made with reference to the preferred embodiments of the present disclosure, it will be understood that a person skilled in the art may variously modify and change the present disclosure set forth in the scope of the following claims.

Accordingly, the present disclosure is not intended to be limited to the embodiments set forth herein, but is intended to have the widest scope consistent with the principles and novel features disclosed herein.

What is claimed is:

1. A device for opening and closing a vehicle door, the device comprising:
a processor configured to detect an obstacle around a vehicle based on an opening command signal or a closing command signal of the vehicle door and calculate a distance to the detected obstacle; and
an actuator configured to control a motor to open or close the vehicle door based on the detected obstacle or the distance to the obstacle,
wherein the processor is configured to control the actuator to open or close the vehicle door at one of a plurality of opening levels or a plurality of closing levels based on the detection of the obstacle or the distance to the obstacle, and
wherein the plurality of opening levels and the plurality of closing levels exclude a fully closed level and a fully open level of the vehicle door.

2. The device of claim 1, wherein the processor is configured to activate an automatic door opening/closing mode based on the command signal for opening or closing the vehicle door.

3. The device of claim 1, wherein the processor is configured to, in response to reception of the command signal for opening the vehicle door, control the actuator to open the vehicle door at an opening level corresponding to the distance to the obstacle.

4. The device of claim 1, wherein the processor is configured to, in response to reception of the command signal for opening the vehicle door, control the actuator to open the vehicle door at a preset opening level.

5. The device of claim 4, wherein the processor is configured to switch an automatic door opening/closing mode to a manual door opening/closing mode and output an alarm notifying the switch.

6. The device of claim 1, wherein the processor is configured to, in response to reception of the command signal for closing the vehicle door:
attempt to detect an obstacle; and
control an alarm notifying the presence of a nearby obstacle to be output when the obstacle is detected.

7. The device of claim 6, wherein the processor is configured to switch an automatic door opening/closing mode to a manual door opening/closing mode and output an alarm notifying the switch when the alarm notifying is the presence of the nearby obstacle is output a preset number of times.

8. The device of claim 1, wherein the processor is configured to, in response to reception of the command signal for closing the vehicle door:
attempt to detect an obstacle; and
control the actuator to close the vehicle door at a next closing level of a closing level of the vehicle door when the obstacle is not detected,
wherein the next closing level includes a closing level where the vehicle door is closed more than a current closing level.

9. A method for opening and closing a vehicle door performed by a device for opening and closing the vehicle door including a processor configured to detect an obstacle around a vehicle based on an opening command signal or a closing command signal of the vehicle door and calculate a distance to the detected obstacle, and an actuator configured to open or close the vehicle door based on the detected obstacle or the distance to the obstacle, the method comprising:
receiving the opening or closing control command signal of the vehicle door; and
controlling the vehicle door to be opened or closed at one of a plurality of opening levels or a plurality of closing levels based on the detection of the obstacle or the distance to the obstacle,
wherein the plurality of opening levels and the plurality of closing levels exclude a fully closed level and a fully open level of the vehicle door.

10. A vehicle comprising:
a sensor configured to obtain data for detecting an obstacle around the vehicle;
a processor configured to detect the obstacle around the vehicle based on an opening command signal or a closing command signal of the vehicle door and calculate a distance to the detected obstacle; and
a vehicle door opening/closing device including an actuator configured to open or close the vehicle door based on the detected obstacle or the distance to the obstacle,
wherein the processor is configured to control the vehicle door to be opened or closed at one of a plurality of opening levels or a plurality of closing levels based on the detection of the obstacle or the distance to the obstacle, and
wherein the plurality of opening levels and the plurality of closing levels exclude a fully closed level and a fully open level of the vehicle door.
